(19) United States
(12) Patent Application Publication
(10) Pub. No.: US 2010/0259804 A1
(43) Pub. Date: Oct. 14, 2010

(54) Illumination Unit Comprising an Optical Wave Guide and an Imaging Means

(75) Inventors: Steffen Buschbeck, Erfurt (DE); Gerald Futterer, Dresden (DE); Stephan Reichelt, Dresden (DE)

Correspondence Address: Saul Ewing LLP (Philadelphia);Attn: Patent Docket Clerk, Penn National Insurance Plaza, 2 North Second St., 7th Floor, Harrisburg, PA, 17101, US

(73) Assignee: SeeReal Technologies S.A., Munsbach (LU)

(21) Appl. No.: 12/745,971

(22) PCT Filed: Dec. 2, 2008
(86) PCT No.: PCT/EP2008/066638

§ 371 Date: Jun. 3, 2010

(30) Foreign Application Priority Data
Dec. 3, 2007 (DE) 10 2007 060 183.4
Oct. 22, 2008 (DE) 10 2008 043 092.7

(51) Int. Cl. G03H 1/00

(52) U.S. Cl. 359/34

(57) ABSTRACT

Disclosed is an illumination unit comprising a strip-type optical wave guide and an imaging means, and providing a very high light efficiency with a reduced number of primary light sources. The illumination unit enables the production of a coherent plane wave field having a temporal and spatial coherence required for holographic reconstructions. The strip-type optical wave guide contains extraction elements for extracting injected coherent light guided into an observer plane by imaging elements via a controllable light modulation means. During the injection of light, the extraction elements form a grid of secondary light sources which are arranged in the front focal plane of the imaging elements and carry out the spatial coherence in at least one dimension. A secondary light source and an imaging element are associated with each other in order to guide the extracted light through the controllable light modulation means in a collimated manner.

The present invention relates to an illumination unit which comprises a strip shaped light waveguide and an imaging means, where the light waveguide has a number of light output coupling elements for injected coherent light to be coupled out, and where the light which is coupled out is directed by imaging elements of the imaging means through a controllable spatial light modulation means into an observer plane, and where the light waveguide is disposed in a plane before the light modulation means and connected to a carrier means.

The illumination unit is meant to be used in a holographic display device where the light which is coupled out of the light waveguide serves to generate an aggregated coherent plane wave field, which is directed at the controllable spatial light modulation means (SLM). The SLM preferably serves as a holographic reproduction means in a holographic display device.

A coherent plane two-dimensional wave field with sufficient temporal and spatial coherence is required to be able to generate a holographic reconstruction of a spatial scene in a holographic display device. This means that a planar wave field with a sufficiently small plane wave spectrum shall be realised with the help of light source means. Lasers, which are known to emit coherent light, are generally used as light source means. Alternatively, a multitude of LEDs arranged in a matrix, which normally emit incoherent light, can be used as light source means. If the light which is emitted by the LEDs is filtered spatially and/or temporally, it will be given the sufficient coherence which is required for holographic representations. However, the larger the diagonal of a controllable spatial light modulator (SLM) which serves as a holographic reproduction means, the greater are the demands made on the coherence and representation quality in the holographic display device.

It is known in the prior art to generate the coherent plane wave field with a single laser light source with a certain emission characteristic, and to combine this light source with a single large collimating lens. The light source is imaged into the observer plane, thereby passing the SLM on which the holographic information of a spatial scene is encoded. The incident wave field is modulated with the encoded information and generates a holographic reconstruction of this scene in a reconstruction space. An observer can watch the holographic reconstruction from a so-called observer window, which is generated between two diffraction orders of the wave field. This combined arrangement of light source and collimating lens has the disadvantage that the numeric aperture of the collimating lens requires a large extent in the Z direction, which increases the structural depth of the holographic display device. A flat display device cannot be realised then without taking additional measures e.g. for shortening the optical path.

Another possibility of generating a plane coherent wave field is to use a matrix of light sources. They can be imaged by an accordingly structured matrix of collimating lenses to the position of observer eyes in the form of a wave field modulated by the SLM. The difficulty in the practical realisation is that a very large number of very small light sources must be arranged in the light source matrix with a very high precision as regards both their mutual constellation and their position in relation to the assigned collimating lenses in order to achieve a good collimation, i.e. a sufficiently narrow plane wave spectrum, and thus the required spatial coherence of the wave field.

For example, given a lens pitch (distance between the centres of adjacent lenses) of the collimating lenses of about 2 mm and a screen diagonal of 20″, about 30,000 light sources must be aligned with very high precision. This requires a manufacturing accuracy which simply cannot be achieved.

Therefore, light source means are needed whose light-emitting surface does not exceed a maximum angular range of the plane wave spectrum in relation to a given collimating lens. An angular range which is too large would adversely affect a point-wise reconstruction of a spatial scene, because the resolution limit of the human eye would then be exceeded, thus causing the object points of the scene to be reconstructed to appear blurred. The resolving power of the eye is about 1°/60 deg. Under optimal conditions, object points which have a larger angle to each other—seen from the observer eye—are perceived as separate points.

It is further commonly known to use a light source means which serves as backlight to illuminate a compact surface-emitting light waveguide. The latter is for example a compact slab made of a transparent plastic material, where the light is injected into a narrow side face of the slab. The transparent slab may exhibit a wedge-shaped angle. The surface which faces the display panel is given a structure of micro-prisms. This design serves to achieve a preferred polarisation of the light to be emitted. In order to increase the portion of the useful light, it is known to apply a depolarising diffuser foil on the back of the plastic slab. This is also referred to a polarisation recycling. The light is emitted from the entire surface of such a waveguide. The angular range of the emitted light is for example around 30° deg, i.e. it is by a factor of 1800 larger than the angular resolution of the human eye. This type of light waveguide is not suited for generating a plane wave field which is meant to illuminate an SLM and to generate a holographic reconstruction. For this purpose, the light beams must only contain portions of plane waves which mutually diverge by an angle of ≦1°/20 deg after a collimation to form a plane wave field.

Other compact planar light waveguides exhibit exit openings through which light can be emitted specifically. The light is first reflected multiple times in the light waveguide before it is emitted. The light which leaves the light waveguide through these output coupling points shall for example be collimated with the help of lenses and after collimation it shall be transmitted as a homogeneous plane wave field to the SLM. In this case of light emission through individual exit openings, the ratio of the surface area for light guidance and the surface area of the local exit openings is so small that the light is substantially attenuated in the light waveguide due to the multiple reflections. This is because a beam which propagates in the light waveguide is transported through the light waveguide many times before it leaves the light waveguide by chance through one of the possible exit openings. This means that the luminous efficiency of such an illumination means is very low, even if the transparent material has a low absorption coefficient. In order to increase the luminous efficiency, the light must be guided through the light waveguide such that it runs directly to the exit openings. If the light modulator which is to be illuminated is for example encoded one-dimensionally, the emitting surface of the secondary light sources should be about 1/7000 of the surface area which is to be illuminated.

In order to improve the optical presentation in a flat colour display device, document DE 691 25 285 T2 proposes to couple the light which is injected into a compact planar light guiding substrate out in various ways at those points where the image pixels or colour pixels are situated in that the condition for total internal reflection (TIR) is violated locally. This makes it possible for red, green and blue light pulses to be injected alternately into the light guiding substrate at a fast pace, so that a large range of colours can be realised. However, it is not desired there to reduce the multiple reflections of the light in the light guiding substrate and thus to increase the luminous efficiency.

It is thus the object of the present invention to provide for a holographic display device a flat illumination unit with a reduced number of primary light sources compared with prior art solutions. In particular, a strip shaped light waveguide with an arrangement of light sources shall be used which realises a very high luminous efficiency. The illumination unit shall further permit a coherent plane wave field to be generated which exhibits a temporal and spatial coherence that is required for holographic reconstructions. Since the finely-structured surfaces of a light waveguide are susceptible to pollution and mechanical damage, such surfaces shall be avoided where possible.

The components of the illumination unit shall be adaptable without much effort to spatial light modulators of any size.

The solution is based on an illumination unit which comprises a strip shaped light waveguide in which the light propagates exclusively by way of total internal reflection (TIR), and an imaging means. The light waveguide has a number of output coupling elements for injected coherent light to be coupled out. A person skilled in the art also refers to output coupling points instead of output coupling elements. The imaging means has imaging elements which deflect the light through a controllable spatial light modulation means into an observer plane. The light waveguide is disposed in a plane before the light modulation means in the optical path and is connected with a carrier means.

The object is solved according to this invention in that when light is injected the output coupling elements form a grid of secondary light sources which are disposed in the front focal plane of the imaging elements and which realise spatial coherence at least one-dimensionally, where each secondary light source is assigned to one imaging element, which directs the emitted light in a collimated manner in the form of a plane two-dimensional wave field through the controllable light modulation means.

The strip shaped light waveguide is connected to a carrier means and has a continuous, non-linear structure. The light waveguide is preferably be disposed in the carrier medium. If it is disposed on its surface, the entire surface is subsequently levelled, as stipulated as one object to be solved.

In a first embodiment, the light waveguide has the form of a meandering optical fibre. In order to achieve the spatial coherence, the individual sections of the meandering optical fibre are preferably arranged in parallel and at a constant distance. In a further physical form of the first embodiment, the optical fibre can also be inscribed by exposure directly into a planar light waveguide, which is thus given regions with optically variable refractive index.

The output coupling elements in the light waveguide are generated either by way of mechanical or lithographic imprint processing or with the help of diffraction gratings.

Both the light waveguide and the output coupling elements can be inscribed by exposure directly into a holographic recording material.

In a further embodiment of the illumination unit, the light waveguide and/or the carrier means are at least partly covered by a photosensitive cover layer for generating the output coupling elements. The output coupling elements in the light waveguide are inscribed by exposure optionally into the photosensitive core or into the photosensitive cladding in the form of volume gratings which are locally confined to the light sources to be realised. The grating plane of the inscribed volume gratings has a planar or curved shape, depending on the size of the secondary light sources to be realised.

At least one laser light source serves to inject the light into the light waveguide. In order to maintain the symmetry of the emission characteristic of the output coupling elements, the light is preferably injected into the light waveguide through at least two points in opposing direction using two laser light sources.

In a second embodiment, the light waveguide is realised in the form of a GRIN lens. The GRIN lens is inscribed by exposure into a transparent carrier means optionally in the form of a waveguide grating or in continuous windings at least two-dimensionally. In a preferred embodiment, the output coupling elements are situated at the intersecting points of the waveguide grating.

The light waveguide can also be realised in the form of a multi-mode light waveguide where the individual modes exhibit a different energy distribution.

The illumination unit can further include a light waveguide with output coupling elements which realise secondary light sources in the form of point sources. They are preferably suited to illuminate a light modulation means which exhibits a two-dimensional encoding.

In order to bring the intensity distribution of the light to be emitted through the individual output coupling elements of the light waveguide to the same level, the geometry and/or size of individual output coupling elements are made different by using individual diffraction gratings.

In a further embodiment of the invention, the imaging elements are provided in the form of an array of collimating lenses. For channelling the emitted light to the collimating lenses, an arrangement of apertures, whose apertures confine the light emission to the assigned collimating lenses, is preferably provided between the output coupling elements and the collimating lenses.

Using the light waveguide in the illumination device is all the more preferred as this minimises the space requirements. The output coupling elements in the front focal plane of the collimating lenses extend over a region which is smaller than a given surface to be illuminated, such as the light modulation means.

An in-situ exposure technique can be employed for holographically generating the output coupling elements or the light waveguide. When doing so, one or both of these components can be holographic optical elements.

The volume grating to be generated can be inscribed by exposure into the light waveguide optionally as a phase-only grating or as an amplitude-only grating.

The grid of the secondary light sources can exhibit a period with a constant horizontal and vertical spacing. Alternatively, the spacing in the grid can increase from the centre of the grid towards its margins.

Further, the output coupling elements are designed such that if secondary point light sources are generated an axially symmetric intensity distribution is realised.

In another embodiment, the light waveguide has coupling points where active modulators are provided for dimming the intensities of individual secondary light sources.

An imaging element of the illumination unit is assigned with at least one output coupling element. However, if the number of output coupling elements per imaging element is much higher, this arrangement can serve for tracking the light sources if the observer changes their position.

If output coupling elements are connected with a controllable layer with reversibly modifiable refractive index in the light waveguide, the emitted light can be directed at the assigned collimating imaging elements as varied depending on the actual control.

The present invention further comprises a controllable spatial light modulation means which is encoded with a diffractive structure of a spatial scene and which is illuminated with a coherent plane wave field which is generated by an illumination unit according to one of the preceding claims.

The illumination unit can thus generate a reconstruction of the spatial scene for an observer who is situated in the observer plane and at whom the light is directed.

The advantage of the illumination unit according to this invention is that compared with the prior art the injected light is guided sequentially or simultaneously along the output coupling elements, so that it can be emitted specifically through a very small area. The length of the optical path which is covered by the light in the material is minimised, thus achieving a high luminous efficiency. The arrangement and design of the output coupling elements as secondary light sources in a light waveguide has the effect that after the collimation a coherent plane wave field which exhibits the required coherence is directed at an SLM. Moreover, the number of primary light sources is significantly reduced compared with the prior art.

A great symmetry in the arrangement of output coupling elements also provides for a great symmetry in the emission characteristic of the thus generated secondary light sources.

Since the illumination unit is of a flat design, the structural depth of a holographic display device can preferably be reduced.

For diffractive structures which correspond to a one-dimensionally encoded hologram, the regions for light exit are preferably designed in the form of lines or line segments, so that the spatial coherence is sufficiently high in the given direction but minimal in the orthogonal direction.

The present invention will be described in detail below with the help of embodiments, in conjunction with the accompanying drawings, wherein

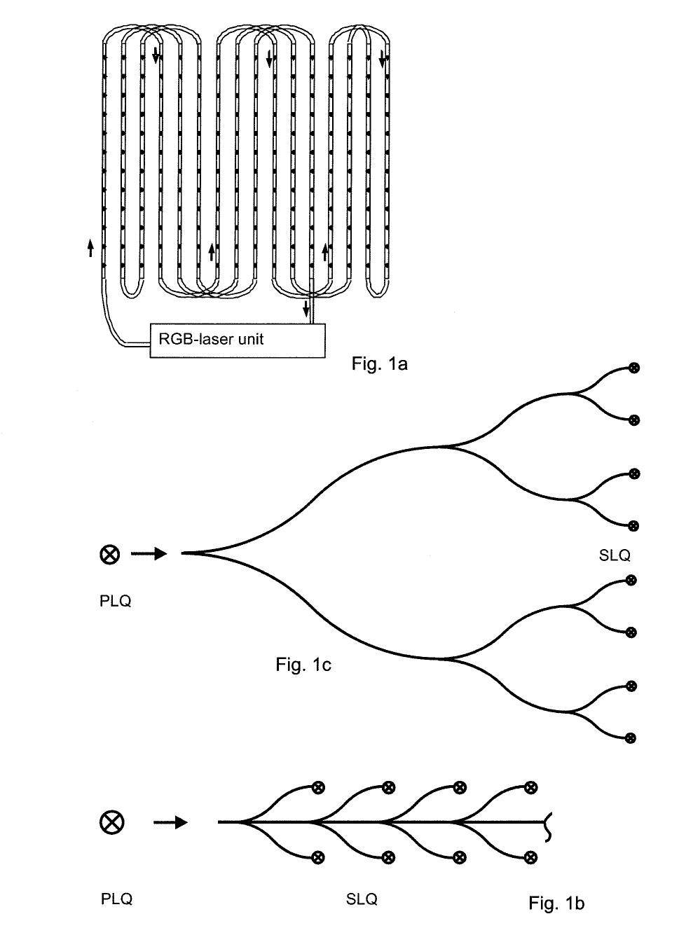

FIG. 1a is a schematic front view which illustrates a first embodiment of a light waveguide according to this invention,

FIG. 1b is a schematic top view which illustrates a second embodiment of a light waveguide according to this invention,

FIG. 1c is a schematic top view which illustrates a third embodiment of a light waveguide according to this invention,

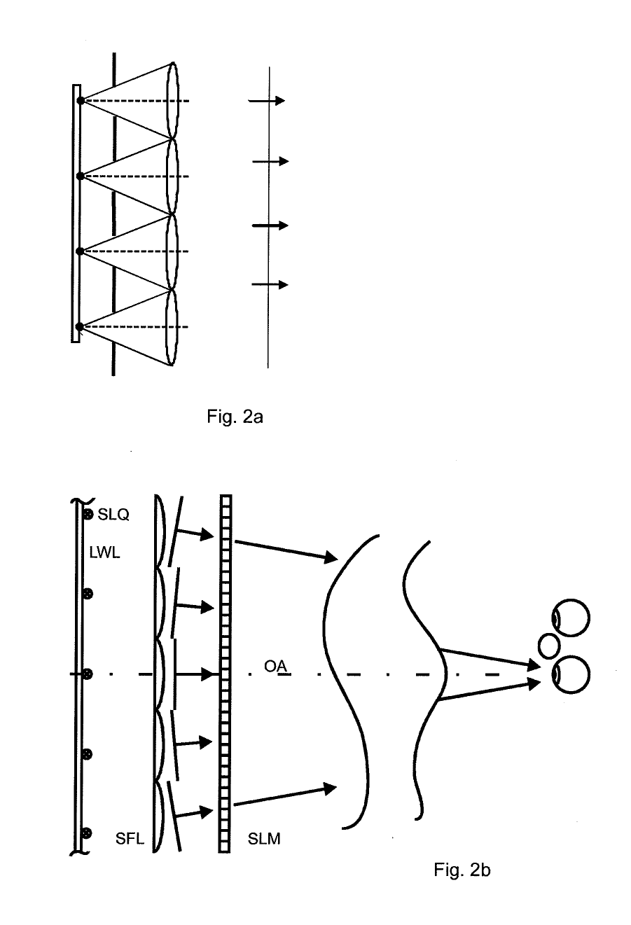

FIG. 2a is a top view which shows schematically a detail of an embodiment of the illumination unit according to this invention,

FIG. 2b is a top view which shows schematically a detail of another embodiment of the illumination unit according to this invention, which serves to realise the function of a field lens,

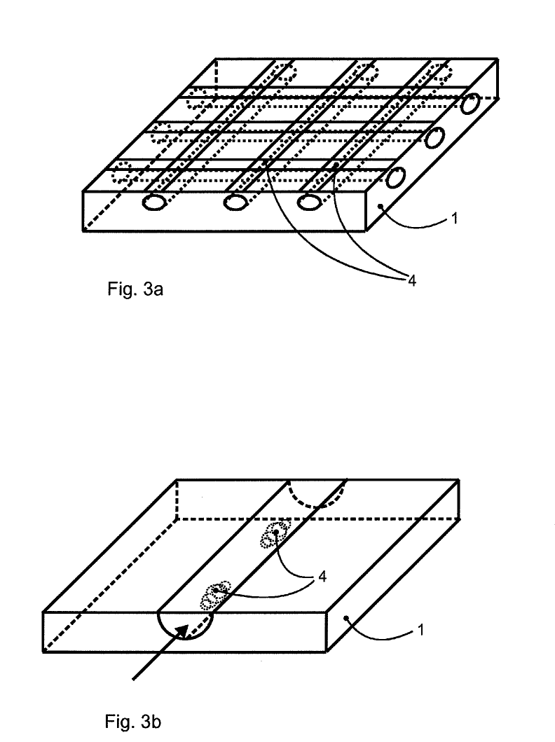

FIG. 3a is a perspective view which illustrates a detail of a second embodiment of the light waveguide as a GRIN lens,

FIG. 3b is a perspective view which illustrates a detail of another arrangement of the light waveguide as a GRIN lens with secondary light sources,

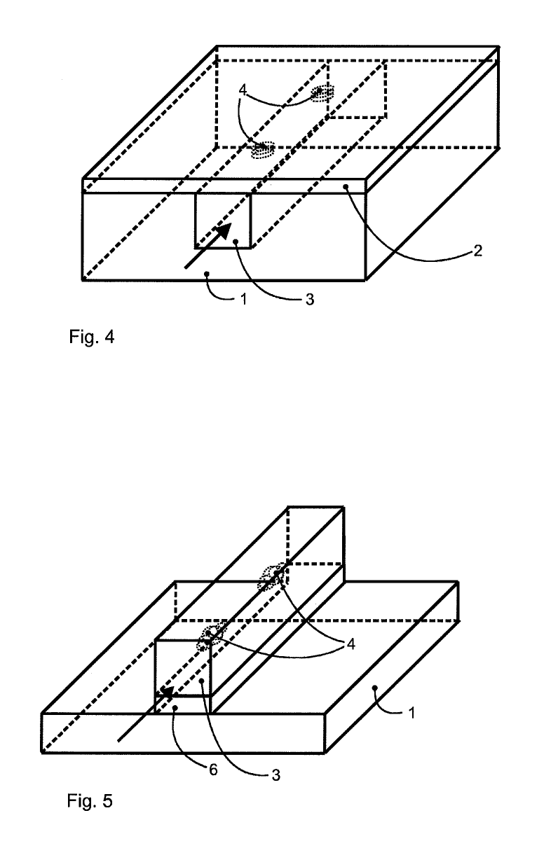

FIG. 4 is a perspective view which illustrates a detail of a third embodiment of the light waveguide with output coupling elements in the light waveguide,

FIG. 5 is a perspective view which illustrates a detail of a fourth embodiment of the light waveguide with diffractive surface profile structures with great refractive index difference which serve as secondary light sources,

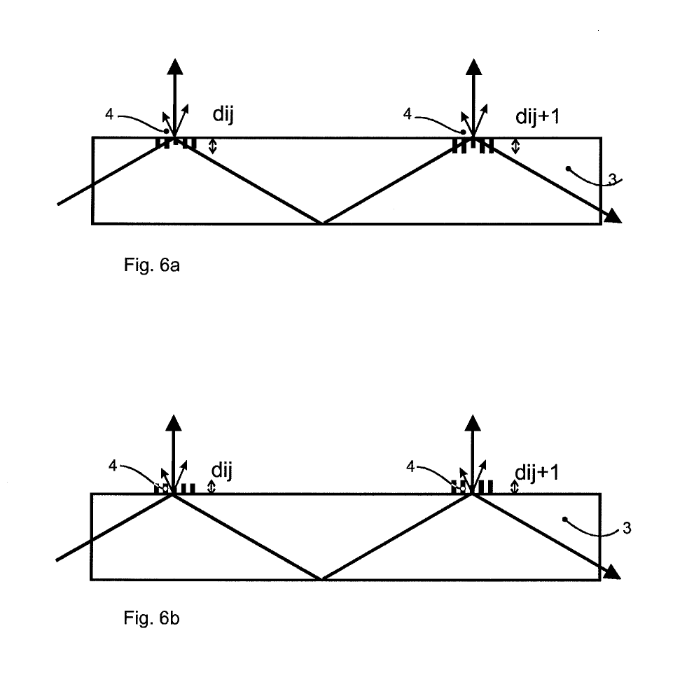

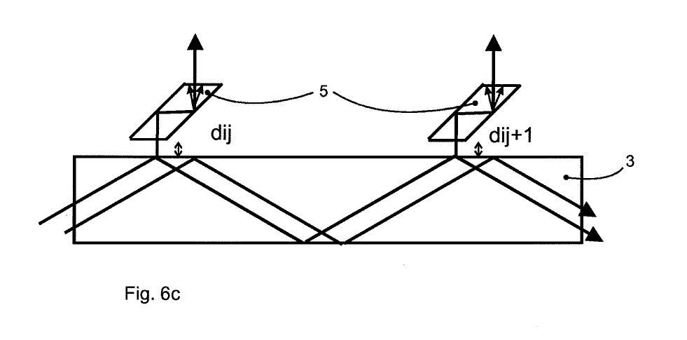

FIGS. 6a-6c are side views which show schematically details of the light waveguide with variable output coupling of light,

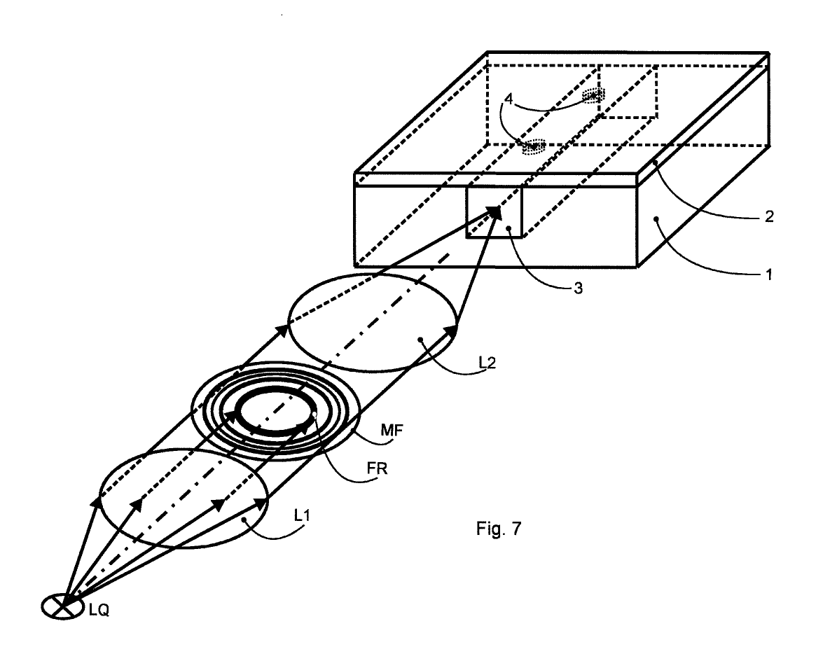

FIG. 7 is a perspective view which shows another embodiment of the illumination unit according to this invention with a light waveguide according to FIG. 4 and an assigned optical component which includes a mode filter,

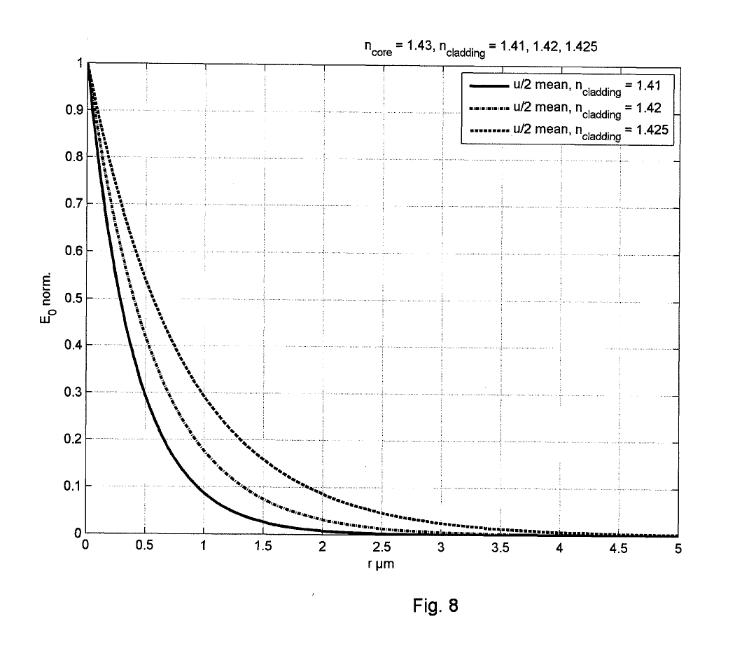

FIG. 8 is a chart which illustrates the energy E₀ of a mode depending on the distance r to the core of the light waveguide for three different cladding materials,

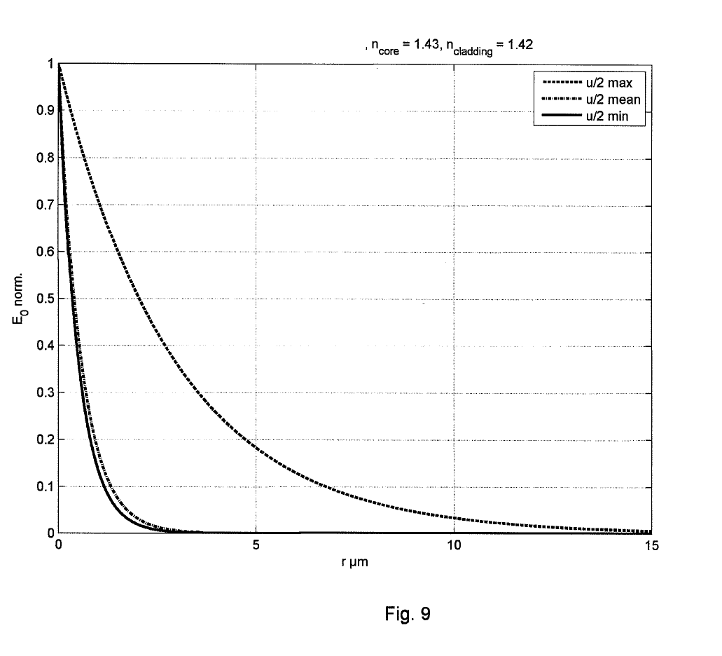

FIG. 9 is a chart which illustrates the energy E₀ depending on the distance r to the core of the light waveguide for three different angles of reflection in the light waveguide,

FIG. 10 is a top view which shows an arrangement according to FIG. 2, where the light waveguide is additionally given a wedge-shaped cover layer,

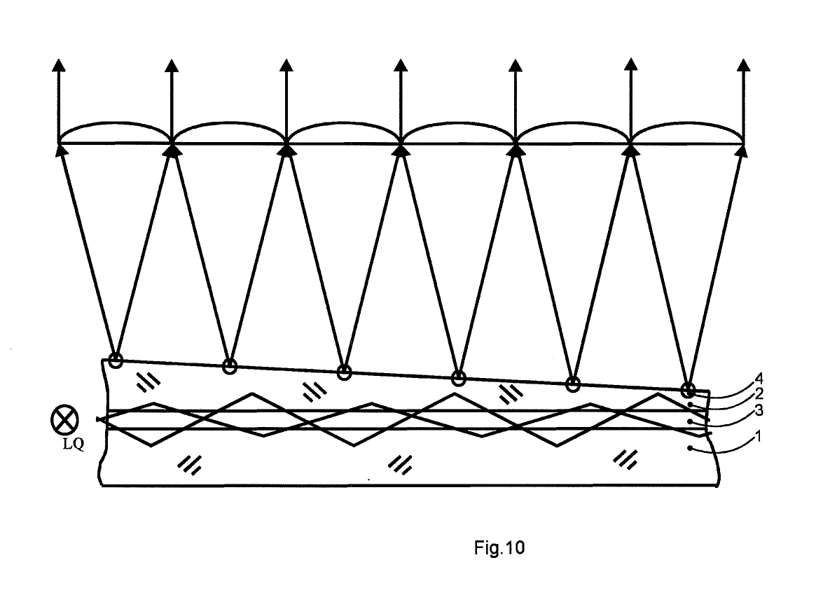

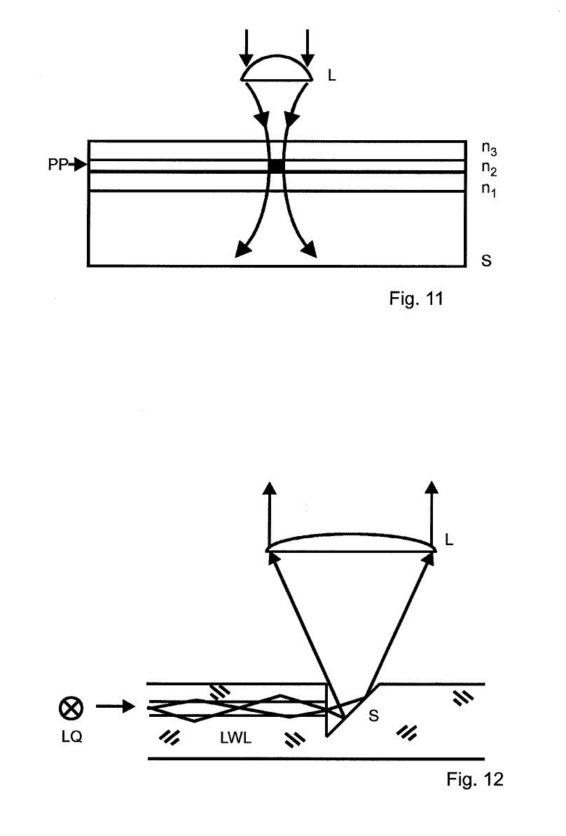

FIG. 11 is a top view which shows an example of a direct inscription by exposure of a given structure of a waveguide into a photosensitive material,

FIG. 12 is a top view which shows an example of the output coupling of injected light at the end of a fibre in a light waveguide according to FIGS. 1b and 1c,

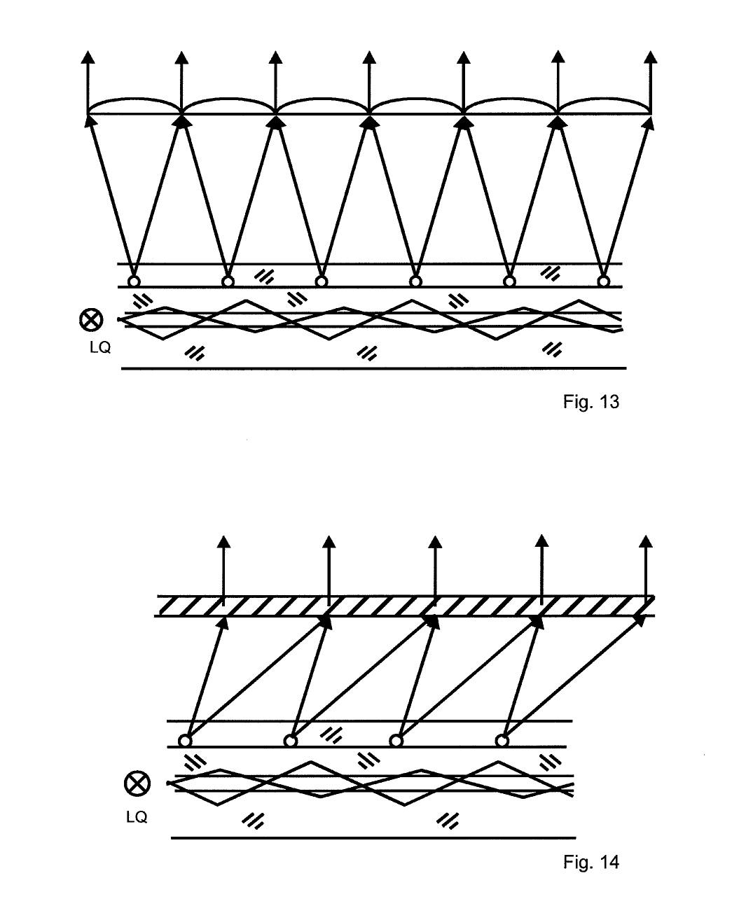

FIG. 13 is a top view which shows an example of the output coupling of injected light through micro-globules,

FIG. 14 is a top view which shows an example of the collimation of injected light through holographically generated lenses,

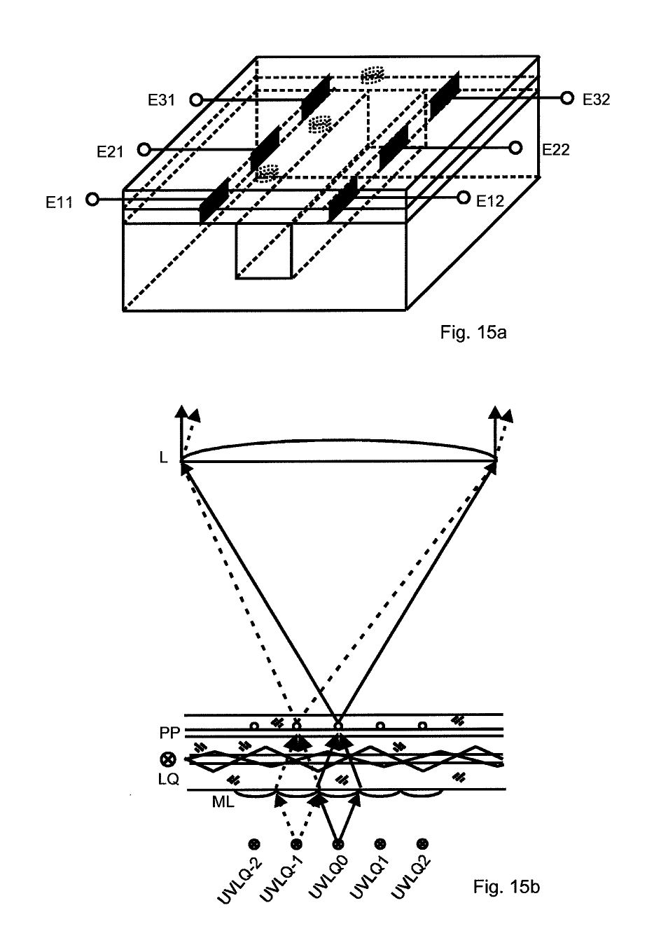

FIG. 15a is a perspective view which shows a first arrangement for controllable output coupling of light out of a light waveguide, and

FIG. 15b is a top view which shows a second arrangement for controllable output coupling of light out of a light waveguide.

The main components of the illumination unit according to this invention, which serves to generate a coherent plane two-dimensional wave field, are a light waveguide and an imaging means. The light waveguide itself is an optical component in which the injected light of at least one light source propagates by way of total internal reflection (TIR). This has a priori the advantage of a very low optical attenuation. The light waveguide generally comprises a core and a cladding, where the refractive index n of the cladding is lower than that of the core.

With the exception of FIG. 1a, all Figures only show details of the light waveguide. Arrows in the drawings indicate the direction of light entry and/or exit.

The light waveguide has output coupling elements for coupling out the injected light, said elements emitting a part of the light out of the light waveguide. It is required to have few very small light-emitting surfaces which serve as secondary light sources.

As shown schematically in FIG. 1a, the light waveguide has a strip shaped design. It can for example be an optical fibre which exhibits a multitude of output coupling elements at constant distances along the fibre.

The light waveguide stretches two-dimensionally in a carrier means (not shown) to cover a given area in a continuous, non-linear structure. The structure in said area can for example be a meandering structure.

The light waveguide has output coupling elements for selective output coupling of light of an RGB laser unit in a two-dimensional regular pattern through which injected light is emitted e.g. sequentially. The output coupling elements are drawn as black spots in FIG. 1a. The region of the output coupling elements is a two-dimensional area in a plane. Since the output coupling elements emit the light under a certain given angle, the two-dimensional area of the secondary light sources can be smaller than a given surface to be illuminated, e.g. a spatial light modulator. The secondary light sources generate an intensity distribution which illuminates the collimating lenses homogeneously. If the light modulator is encoded two-dimensionally, point light sources shall preferably be generated in the light waveguide as secondary light sources.

In such an arrangement of output coupling elements, the light proceeds in the light waveguide on the shortest route from one output coupling element to the next one. The desired high luminous efficiency is thus realised in an array of secondary light sources. Referring to FIG. 1a, since the injected light circulates, the light is emitted asymmetrically through the output coupling elements. In order to compensate this, light can additionally be injected by a second RGB laser unit through the other side of the optical fibre. Depending on the size of the modulator surface to be illuminated, even more RGB laser units can be integrated into the course of the optical fibre.

The emission characteristic of the output coupling elements further depends greatly on their geometry and/or size. These two factors must also be taken into account when compensating the light loss.

The optical fibre can also be a fibre laser which is generally doped with colorants. In practice, this can be a meandering strip shaped light waveguide strand whose fibre ends are mirrored. The generation of a fibre Bragg grating at the fibre ends corresponds with the introduction of a wavelength-dependent reflectivity. This makes it possible to realise a small spectral line, i.e. a great temporal coherence and thus a great coherence length, which is required when tracking the visibility region with the help of electrowetting prisms.

The active fibre which is embedded into a transparent material can for example be pumped with UV radiation (UV diodes), which propagates in the transparent material by way of total internal reflection (TIR). The active fibre can also have along its path passive light waveguide branches and light waveguide coupling points which run to individual secondary light sources or groups of multiple secondary light sources. This is shown schematically in FIGS. 1b and 1c.

FIG. 1c shows how light of a primary light source PLQ is coupled out through Y-type couplings, each of which being assigned to a secondary light source SLQ. The injected light is coupled into an optical fibre. Y-type couplings in the central optical fibre serve to couple out a part of the light and to guide it further to an output coupling element which is formed into a secondary light source. One Y-type coupling is provided for each secondary light source SLQ. Each individual Y-type coupling couples out only few percent of the guided light, e.g. only 0.1%.

FIG. 1b shows how light of a primary light source PLQ is coupled out through 50%/50% Y-type couplings, each of which being assigned to a secondary light source SLQ.

The Y-type couplings which are used in this arrangement split the incoming light in equal parts and couple it into two continuing fibres. This arrangement also allows an array of secondary light sources SLQ to be generated. A disadvantage of this arrangement is its great space requirement. The arrangements of FIG. 1b and 1c can also be combined. The arrangement shown in FIG. 1b can for example serve as a continuation of the arrangement in FIG. 1c on the right-hand side.

A planar, flat design can also be realised if optical fibres are arranged side by side along the edge of a coplanar plate and individually guided to output coupling elements. A primary light source is focused in the form of a focal line on the fibre ends which lie side by side. This arrangement can be exposured in the photosensitive layer e.g. by way of a contact copy.

Very much like e.g. a direct optical inscription of light waveguide structures into a transparent photosensitive layer or the replication of a master structure, the realisation of local light waveguide branches as described above represents a cost-efficient manufacturing process for a light waveguide of the illumination unit.

The cost-efficient manufacture with a light waveguide structure which has a slightly more elaborate design makes it possible to achieve a simple design of the output coupling elements. They can for example simply comprise an array of prisms which is embossed in the surface or which is generated with the help of laser ablation. This simple type of output coupling elements, which comprises the end of a light waveguide and a prism which deflects the wave field, can preferably be employed when a single-mode light waveguide is used.

FIG. 2a shows a detail of an embodiment of the illumination unit according to this invention.

The output coupling elements, which are drawn as black spots on the left in FIG. 2a, are arranged in the light waveguide in a two-dimensional plane which lies in the front focal plane of the collimating lenses and couple the injected light out at an editable intensity and in a defined angular range. When coupling out the light, a given design of the output coupling elements generates secondary light sources in the light waveguide with a required intensity distribution. If the output coupling elements realise point light sources, then the light which propagates through them resembles the wave field of a point light source.

The illumination unit comprises in addition to the light waveguide an imaging means which comprises an array of imaging elements, preferably collimating lenses, which may be of a diffractive or refractive type. In a further embodiment, the collimating lenses and output coupling elements can also be inscribed holographically by way of in-situ exposure. A collimating lens and a secondary light source are mutually assigned to form a collimating unit. In a most simple case, they have a common optical axis, which is indicated by a broken line in the drawing.

The array of light sources can also lie on a slightly but uniformly curved surface and form a collimating unit together with an array of collimating lenses which lie on a likewise slightly curved surface. Each collimating unit generates a plane two-dimensional wave field, which is directed through a subsequent controllable light modulation means into an observer plane and superposed at an eye position. Thanks to the slightly curved surfaces of the two arrays, the function of a field lens can be realised at the same time. This is achieved by segments of planar wave fronts which have an angle to the optical axis of the SLM or display panel which depends on their position. This angle has a maximum value at the edge of the display panel, and the value zero in the centre of the display panel.

This is shown in FIG. 2b. In this Figure, LWL denotes the strip shaped light waveguide, SLQ the secondary light sources, SLF the segmented field lens, and SLM the light modulator, where all these components are shown in a top view. The secondary light sources SLQ are situated the more off-centre of the collimating micro-lenses of the field lens SLF the farther they are away from the optical axis OA of the entire system. This arrangement serves to generate a modulated wave front which consists of segments of plane wave fronts, which is modulated with a field lens function, and which realises a given deflection of the wave front. The generated wave front illuminates the SLM and is further directed at an eye position of a user, where the focus of the field lens SLF lies. This realises a convergence of the wave front which is coming from the SLM into the eye of the user.

If lens diameter and distance between the lenses remain constant across the entire array, the distance between the secondary light sources increases the farther they are away from the optical axis of the display device. Alternatively, the lens diameter and distance between the lenses can be modified such that the distance between the secondary light sources can remain constant across the entire array.

The field lens function serves to vary parameters such as distances of the secondary light sources, and corresponding distances of the assigned collimating micro-lenses.

Further, the position of an individual light source in relation to the optical axis of the accordingly assigned collimating micro-lens can be varied across the entire wave field to be generated, i.e. towards the edge of the array.

In autostereoscopic and holographic displays, this can be realised by varying the period of the vertically disposed cylindrical lenses which serve as imaging means in at least one dimension. If micro-lenses other than cylindrical lenses are used, this can be realised in two dimensions.

An arrangement of apertures, which can for example be a grating, is disposed between adjacent output coupling elements. The emission characteristic of the output coupling elements, the form of the grating of the arrangement of apertures, and the shape and size of the imaging elements are matched accordingly.

The arrangement of apertures confines the emission angle of the output coupling elements, thus ensuring that the light of the secondary point light source is collimated by the assigned lens only. The spatial coherence is thus maintained for each light source. The width of the angular spectrum can thus be limited to a range of <1°/60 deg. The array of collimating lenses illuminates a given surface with a plane coherent wave field whose plane wave spectrum is sufficiently small, but whose spatial coherence is sufficiently high. The temporal coherence is given by the spectral width of the used light sources.

This wave field can be used to illuminate an SLM which has the function of a holographic display matrix for a spatial scene. The reconstruction quality is thus preferably improved.

When coupling out the injected light, it is also important to observe the emission characteristic of the output coupling elements or secondary light sources according to Lambert's cosine law. An emission in a limited angular range around the surface normal of the light waveguide would be ideal.

FIG. 3a shows schematically a second embodiment of a light waveguide according to this invention. A line grating which serves as the light waveguide is inscribed by exposure into a substrate which serves as the carrier means 1 for the waveguide along lines in the surface which are situated at right angles. The light waveguide is realised in the form of a GRIN lens here. The GRIN lens has the form of a two-dimensional plane waveguide grating, which is indicated in the drawing by the dotted lines in the substrate. The line grating of the light waveguide is situated in the carrier means 1 in a plane which is parallel to the substrate surface. The output coupling elements 4 are generated at the intersection points. As in the first embodiment, the injected light is guided from one output coupling element of the waveguide grating to the next and coupled out e.g. through point exits. The carrier means 1 has the form of a slab, so that it preferably contributes to reducing the structural depth of a display device.

In the Figures, the carrier means 1 is normally made of a transparent material. Non-transparent forms which allow local output coupling of injected light and which are not mentioned explicitly here shall also be embraced by these embodiments.

FIG. 3b shows a different type of a GRIN lens-based light waveguide. The GRIN lens is generated in the carrier means 1 in two-dimensional continuous windings e.g. by way of doping or other kind of modification of the carrier means 1 in a two-dimensional plane. FIG. 3b shows exemplarily two output coupling elements 4. All output coupling elements 4 are equally spaced within this plane. The distances may alternatively have a period which varies uniformly from the centre towards the edge of the plane.

Both embodiments realise in a simple way an array of secondary light sources which, in conjunction with the collimating lenses, illuminate the surface of an SLM.

A further embodiment of a light waveguide has output coupling elements in the form of diffraction gratings, e.g. as HOE.

FIG. 4 is a perspective view which shows a detail of a third embodiment of the light waveguide 3 with output coupling elements 4. The transparent carrier means 1 includes a light waveguide 3 with rectangular cross-section and is covered by a photosensitive transparent cover layer 2 made of a polymer. Output coupling elements 4 are generated atop the core of the light waveguide 3 in the form of locally confined volume gratings e.g. by generating interference patterns, ion diffusion or by way of inscription techniques. Two exemplary output coupling elements 4 are shown in the drawing. They are generated as the photosensitive cover layer 2 is exposed and represent the secondary light sources. Alternatively, they can be inscribed by exposure directly into the core of the light waveguide 3.

If plastic materials such as PMMA or PDMS, which can be doped or modified easily, are used for the light waveguide 3, a small refractive index variation can be realised during exposure. A HOE which is spatially confined to the size of an output coupling element, can be generated e.g. as a scattering point cloud which is generated when exposing the material with a speckle pattern.

Alternatively to the refractive index variation, which prevents absorption loss, the point cloud can be generated by way of absorption variation.

A tailor-made holographic output coupling element can be realised with the help of in-situ exposure. For this, coherent light is coupled into the light waveguide which is to be exposed. Either the core or the cover layer which is close to the core and in which wave propagation takes place as well is made of photosensitive material for this. At the same time, a plane wave is directed at a lens which focuses the light on the point of the output coupling element which shall be generated. The coherent superposition of light which propagates in one mode of the respective photosensitive component of the light waveguide and of light which is focused into the focal plane of the lens generates the desired hologram. The lens which is used for in-situ exposure corresponds at least as far as its apex angle is concerned with the collimating lens which is assigned to the generated output coupling element. The lens array which is used for collimating the array of output coupling elements can also be employed as a whole or in part for the in-situ exposure.

A simple solution is to use an opaque material which is printed on the light waveguide, thereby generating the output coupling elements. Alternatively, a local depression in or on the light waveguide can be filled with an opaque material. The degree of scattering can be adjusted variably by choosing the material parameters accordingly.

FIG. 5 is a perspective view which shows a detail of an arrangement of output coupling elements, which are generated as a diffractive surface profile structure. A light waveguide 3 is disposed on a carrier means 1. It is isolated from the carrier means 1 by a low-refractive layer 6. The layer 6 and the light waveguide 3 exhibit a large refractive index difference. Output coupling elements 4 are generated in the form of locally confined structures which are equally distributed in the light waveguide 3 by way of optical inscription e.g. with a laser. These output coupling elements 4 again serve as secondary light sources of the illumination unit according to this invention.

The arrangement of the light waveguide 3 forms a profile on the carrier means 1 which extends two-dimensionally in the form of parallel stripes or in the form of a grating. In order to get a smooth overall surface, the spaces between the upper face of the light waveguide 3 and the upper face of the carrier means 1 can be levelled, e.g. by filling it with a transparent low-refractive polymer.

FIGS. 6a to 6c are schematic drawings which show examples of variable output coupling of light through the output coupling elements of a light waveguide 3. In the drawings, only one light beam is shown in the light waveguide which is representative of the multitude of light beams which propagate in the light waveguide 3 by way of total internal reflection.

When light is guided along the output coupling elements, the product of actual intensity and output coupling efficiency must be constant at all output coupling elements across the entire surface of the light waveguide. Since the subsequent output coupling elements receive less light, because light has already been coupled out earlier, the output coupling efficiency of subsequent output coupling elements must be higher if the light is running in one direction only. This is to ensure that the same amount of light is coupled out through each of the output coupling elements.

This is achieved by a different height of the profiles dij and dij+1 of the structured output coupling elements 4, which are illustrated by black bars in FIG. 6a and FIG. 6b. Depending on the actually employed manufacturing method, the output coupling elements can be disposed on or in the light waveguide 3. The output coupling elements can be generated by way of laser ablation, nano-imprint lithography or holographic exposure.

The diffraction efficiency of the output coupling elements can be varied with increasing path length of the light in order to compensate the light loss which occurs during the further propagation of the light in the light waveguide 3. The profile of the structures thus becomes the larger the longer the covered path length, if the light propagates in one direction only.

FIG. 6c shows an embodiment where a layer of micro-prisms 5 is disposed atop the light waveguide 3 in the range of evanescent waves, which allow locally variable output coupling of light. Light is coupled out through them with a certain illumination cone whose intensity is can be varied. The variable distances of the profiles to the core of the light waveguide 3 are denoted as dij and dij+1 again. According to the decreasing intensity of the light which propagates in the light waveguide 3, the distance between the micro-prisms 5 is reduced as the length of the light waveguide 3 increases. A multitude of light beams runs through the light waveguide 3, of which only two are shown exemplarily in the drawing.

A low-refractive cover layer can additionally be disposed between the light waveguide 3 and the micro-prisms 5. The micro-prisms 5 can be disposed on or in this cover layer.

The structure of the profiles and micro-prisms 5 also depends on whether the light is injected into the light waveguide 3 from one side or from two sides. If light is simultaneously injected into the light waveguide 3 from two sides, the emitted light efficiency is increased.

In order to realise a smooth overall surface of the carrier means 1 with the micro-prisms 5 arranged on top, the volume is filled with transparent material, i.e. a low-refractive polymer, so to level the surface.

A further factor which is to be taken into consideration when using a light waveguide in an illumination unit is the penetration depth of the evanescent electromagnetic field in the light waveguide. This field exists outside the medium in which the total reflection takes place. Its energy decreases exponentially as its distance to that medium grows.

The illumination unit can thus be modified with the help of output coupling elements in a strip shaped multi-mode light waveguide. Different modes show different penetration depths in the cladding material of the light waveguide. Consequently, different modes are coupled out at different positions of the light waveguide if the cladding material has a reduced thickness, i.e. after different optical path lengths covered in the light waveguide. Higher modes are coupled out earlier, and lower modes are coupled out later.

Irregularities in the output-coupled energy can be compensated by modifying of the energy distribution in the individual modes.

FIG. 8 is a graphic representation of the energy distribution E₀ of a medium mode outside the core of the light waveguide, i.e. of an average light propagation angle with respect to the axis of the light waveguide. It is exemplarily given for three different refractive indices n_{cladding} of the cladding material depending on the distance r to the core of the light waveguide. As the refractive index difference to the core decreases, the penetration depth of the evanescent electromagnetic field rises. The term “u/2 mean” denotes the mean half apex angle of the light waveguide.

The penetration depth depends, besides the distance r to the core and the refractive indices of the core (n_{core}) and cladding (n_{cladding}), on the angle of the mode which propagates in the light waveguide. The energy E₀ decreases as the distance to the core of the light waveguide grows.

If the geometry of the output coupling elements is constant, the thickness of the cover layer d(z) can be varied to achieve a constant magnitude of the energy which is coupled out through the output coupling elements. According to an optimisation, the gradient of the thickness of the cover layer can be adapted to the actual non-linear relationship. This can be done for example with the help of a linear evaporation source. The relative movement between substrate and linear evaporation source must then be chosen accordingly.

One problem attached to this solution is that different modes of a multi-mode light waveguide propagate in the light waveguide at different angles, thus showing different penetration depths of the evanescent electromagnetic field in the cladding material. This is shown in FIG. 9.

FIG. 9 shows graphically the dependence of the penetration depth of an evanescent electromagnetic field on different reflection angles in the light waveguide, where u denotes the apex angle of the light waveguide. The zero mode with the mode number m=0 corresponds with the u/2 min curve, and the highest mode corresponds with the u/2 max curve. The zero mode propagates parallel with the optical axis of the light waveguide. The highest mode propagates at the maximum possible angle at which total internal reflection occurs. The refractive index of the cladding is lower than that of the core, which results in total internal reflection.

Said problem of different propagation in the light waveguide can for example be circumvented by directly inscribing or exposing the strip shaped light waveguide in photosensitive materials, or holographically with output coupling elements generated by way of in-situ exposure, while maintaining a constant thickness of the photosensitive material of the carrier means.

The direct inscription into photosensitive materials, e.g. into a photopolymer, represents an inexpensive way of generating a matrix of secondary light sources. The desired structure of the light waveguide can be written with a laser beam which runs over the surface of the photosensitive material to be structured and which is focused on the latter. The material can be a known holographic recording medium, or generally a material where local exposure to radiation results in a local modification of the refractive index. A layer thickness which corresponds with the thickness of the core of the wave-guiding structure, and which is e.g. (1-5) μm for single-mode light waveguides or e.g. 50 μm for multi-mode light waveguides.

The exposure described above is shown in FIG. 11. L denotes the focusing lens, S the carrier substrate of the photosensitive material, and PP the photopolymer. Further, n1 is the refractive index of the bottom cladding material, n2 is the mean refractive index of the core material, and n3 is the refractive index of the upper cladding material, i.e. of the cover layer.

During the exposure, the refractive index of the photopolymer is raised in the focal point, which is shown as the narrowest point of the bundle of rays, whereby the condition for light wave guiding is satisfied in this point. The induced refractive index modulation, i.e. the local increase in the refractive index, is proportional to the exposure energy of the writing light and can thus be varied by the latter.

Moreover, materials are known whose refractive indices in the spectral range of visible light are modified by exposing them to X radiation. Positive or negative exposure techniques can be employed, in analogy with photographic or lithographic processes. The light guiding core can represent either the exposed or the non-exposed volume.

If there is no upper cover layer at the beginning of the given structure of the light waveguide or if the existing upper cover layer is very thin, then a contact copy technique may be used to generate the core of the wave guiding structure within the photopolymer. The distance of the disposed mask (e.g. chrome structure on a glass substrate) to the photopolymer should be small enough to prevent undesired broadening of the wave guiding structure as caused by diffraction effects. If X radiation is used for structuring, the distance between mask and photopolymer can be larger without effecting a substantial broadening of the structure, since the effects of diffraction are marginal.

In analogy with the in-situ exposure of output coupling elements by superposition of the guided modes and a converging wave front described above, in-situ exposure is possible here as well.

After exposure, i.e. after structuring the light wave guiding core, the in-situ exposure of the output coupling elements will be carried out. The diffractive volume grating to be generated can be exposed either in the core of the light waveguide or in the cover layer. It must be made sure in any case that the refractive index modulation which can still be achieved in the core or cover layer is sufficiently large.

The cover layer can further exhibit a spectral sensitisation which differs from that of the photosensitive layer of the core material, so that the exposure of the core, which takes place first, does not affect or even desensitise the cover layer.

A cover layer, which is e.g. made of a photopolymer, and which is situated atop the core, can alternatively be deposited on the core only after direct structuring of the core by way of laminating it onto the latter.

In a multi-mode light waveguide the output coupling at constant intensity of the light coupled out through all output coupling elements corresponds with a discharge of the energy in the individual modes. The discharge starts with the highest mode. This is the mode which exhibits the greatest angle to the axis of the light waveguide and the largest penetration depth of the evanescent electromagnetic field in the cladding material.

The influence of the mode filter on the propagation of the light of individual modes in the multi-mode waveguide is limited to short propagation lengths or path lengths. Energetically discharged modes can be energised again by way of energy transfer from other modes. The necessary length of the light waveguides depends on the refractive index distribution and on the scattering within the light waveguide.

One solution provides the analysis of the output-coupled intensity distribution and the adaptation of the mode spectrum of the light waveguide. This means that the intensities of the individual modes are adapted variably to the path length covered in the light waveguide. A mode filter MF which is used in the arrangement according to FIG. 7 serves to realise this. If the intensities coupled out vary along the light waveguide, this variation can be compensated in that the intensity of individual modes is raised or lowered. The mode number m of the mode whose intensity is to be modified is the lower the farther the affected output coupling element is away from the point of light injection.

The mode filter can e.g. have the form of an element which specifically reduces the intensity of the defined angles or a beam-shaping element, i.e. for example a computer-generated hologram (CGH), which enjoys a better energy balance than an absorbing mode filter. If the variation which generally occurs in the output-coupled intensities and thus in the intensity modifications of defined angular ranges, i.e. modes of the mode number m, to be introduced is low, an absorption profile represents a simple and inexpensive solution. The absorption profile is used on the side of light injection into the multi-mode waveguide, e.g. in the central focal plane of a telescope which images the light exit surface of a light source onto the entry opening of the light waveguide. This shall also apply if an individual absorption profile of the mode filter must be generated for each illumination unit following a calibration of the intensities coupled out.

The use of a mode filter MF which is based on an amplitude distribution in the rear focal plane of a lens L1 which collimates the light emitted by the light source, is shown in a perspective view in FIG. 7.

FIG. 7 illustrates a further embodiment of the illumination unit according to this invention. It comprises a light waveguide 3 as shown in FIG. 5, which is assigned with an optical component with a mode filter MF which is sandwiched between two lenses L1 and L2. The light which is emitted by a light source LQ is collimated by the lens L1 and injected into the light waveguide 3 through the lens L2. Referring to FIG. 7, the inner filtering ring FR (strong line) of the mode filter MF prevents light beams from proceeding through the lens L2 into the light waveguide 3. This serves to specifically control the intensity of the light to be coupled out through the output coupling elements 4.

An SLM can be used as a dynamic mode filter MF. This allows for example a specific modification of the intensities of individual modes during the operation of the illumination unit. In a most simple case, an amplitude-modulating SLM can be used. If the dynamic intensity modifications to be introduced are small, this is a practicable solution. If the intensity modifications are large, it lends itself to use a phase-modulating SLM as a beam-shaping element.

The intensity distribution along the output coupling elements can be varied specifically on the injection side if a multi-mode light waveguide is used in the illumination unit.

FIG. 10 illustrates another embodiment of the light waveguide 3 based on FIG. 4, where the cover layer 2 is wedge-shaped. The cover layer 2 can be made of a photosensitive material if the output coupling elements 4 are to be generated by way of exposure. The wedge shape causes the generated output coupling elements 4 to exhibit different distances to the following array of micro-lenses. A light source LQ illuminates with different modes the light waveguide 3, where two propagating modes are shown exemplarily in the drawing with different penetration depths.

The thickness of the cover layer 2 varies in a range of 10 μm, and the focal length of the collimating micro-lenses is e.g. 50 mm. The distance variation can be neglected here. The plane of the micro-lenses can also be aligned precisely parallel with the plane of the output coupling elements 4.

If the light is guided in an optical fibre to the output coupling element of a single secondary light source, then the output coupling element can also be realised by an oblique reflecting surface. This is shown in FIG. 12.

Referring to FIG. 12, LQ denotes the light source, LWL the light waveguide, and S the reflective surface. The light waveguide can be a single-mode or multi-mode light waveguide.

The wedge-shaped recess at the exit end of the optical fibre can be made e.g. by way of hot embossing or laser ablation. The oblique surface does not necessarily have to be a plane, it can exhibit a curvature, for example a spherical curvature. In a preferred embodiment of the reflective surface S, it can also be an extra-axial paraboloid mirror; which can also be made inexpensively and with the necessary precision using embossing or moulding techniques.

In a further embodiment of output coupling elements, micro-globules which have a size of several wavelengths, e.g. a diameter of 10 wavelengths, can be disposed atop the strip shaped light waveguide structures. They form a globular cavity which can realise a large emission angle. The refractive index and the surface of the micro-globules can be adapted variably in the light waveguide. The light preferably propagates in opposing directions through the light waveguide. The micro-globules can also be embedded into low-refractive material such that a plane surface is achieved. This is shown in FIG. 13.

The refractive indices of the layers and the distances to the micro-globules are chosen such that the evanescent field extends up to the micro-globules. The emitted wave field is collimated by an array of micro-lenses. The output coupling efficiency of the micro-globules can be adjusted. For this, a spacer layer is disposed between the core of the fibre and micro-globules, where the thickness of said layer can for example be varied locally.

Output coupling elements which exhibit sufficient spectral selectivity can generally be disposed spatially separated along the strip shaped light waveguide. The collimated plane waves in the primary colours RGB then have a fix small angle to each other. This angle is known from geometrical relations and can be taken into consideration during encoding, so that all three primary colours are congruently superimposed in the reconstruction of the object point and the desired colour value is correctly represented.

The wave fronts which are emitted from secondary light source points of a spatial matrix can be collimated by refractive or diffractive holographically generated micro-lenses in order to realise a planar illumination wave front made up of individual segments of planar wave fronts according to FIG. 2b.

In addition to surface profile gratings, volume gratings as shown in FIG. 14 can be used to satisfy the function of collimating micro-lenses. These diffractive micro-lenses can be axially symmetric or exhibit any other symmetry than axial symmetry. The holographic micro-lenses can be generated independent of the secondary light source points. They are preferably used where secondary light sources have an emission characteristic which can not or only with great difficulty be collimated.

Using holographically generated micro-lenses as volume gratings has the advantage that the array of collimating micro-lenses has a planar design. The volume grating described comprises a film which has a thickness of just 10 μm, for example.

A further advantage is the possibility that wave fronts emitted by primary light sources with oblique emission characteristic can be collimated and propagated in a desired direction. This improves the freedom of design.

In the embodiments of the light waveguide which are illustrated in FIGS. 1b and 1c, where individual secondary light sources SLQ are generated with minimal path length, if active modulators are disposed at the coupling points which lead to the secondary light sources SLQ, then the intensities of individual secondary light sources SLQ can be modified specifically and actively by way of local dimming. This allows laser power to be saved and the power consumption to be reduced. The modulators are designed such that they modify the refractive index and thus the coupling efficiency of the individual coupling points. A coupling point is the point in the light waveguide where the light waveguide branches out.

A modification of the coupling efficiency can also be achieved by way of varying the distance between two closely situated interfaces.

Output coupling elements in the form of micro-globules can also be designed such to achieve local dimming, e.g. in that the distance between the micro-globules and the core of the light waveguide is varied. For this, a fluid with a refractive index which is lower than that of the core and than that of the globule can be disposed between core and micro-globule. It is thus achieved that the distance variations which are introduced for modulating the output coupling efficiency do not become too small.

Local dimming can also be combined with individual secondary light sources with minimised path length in the light waveguide in that annular resonators are used for coupling the energy of the main light waveguide into the secondary light source light waveguides which branch out, as shown in FIG. 1c, which can be varied as regards their refractive index of the annular core or of the surrounding cladding material, and which can thus be switched actively. Non-linear optical polymers can be used for a switchable modification of the refractive index.

A change in the refractive index difference of an annular resonator (i.e. the difference between the core and cladding) which is used for light coupling, or that of a strip shaped structure which is also used for coupling an evanescent field, can for example be achieved electrically or optically.

The principle of local dimming can be used for tracking the secondary light sources. For this, multiple controllable output coupling elements are disposed closely side by side, so that for example 11 controllable output coupling elements are disposed under a collimating lens.

FIG. 15a is a perspective view which shows a first arrangement for controllable output coupling of light out of a light waveguide with three output coupling elements which represent three secondary light sources. This arrangement serves to vary the portion of light which is coupled from the light guiding core into a controllable layer which accommodates the output coupling elements. The output coupling elements are shown as dotted circular elements in the layer in said drawing. The refractive index of this layer is modified depending on the applied control voltage, such as is the case e.g. in non-linear optical polymers. As a control voltage is applied e.g. between the electrodes E11 and E12, the refractive index rises and the penetration depth of the evanescent field into the surrounding of the core increases, whereupon the light is guided to the corresponding output coupling element. The latter is for example a spatially confined volume grating.

FIG. 15b is a top view which shows a second arrangement for controllable output coupling of light out of a light waveguide, where the refractive index difference between the light guiding core and the cover layer is varied by way of optical addressing. The light of individual LEDs which emit light e.g. in the UV range is focused by micro-lenses ML on the photosensitive layer PP (e.g. a photopolymer), where it effects a local increase in the refractive index. The increase in the refractive index leads to an increase in the amount of coupling the evanescent field into the cover layer which accommodates the output coupling elements to be addressed, i.e. the secondary light sources. The photosensitive layer can also be disposed directly atop the light guiding core.

The direction of the plane wave which exists behind the collimating lens L depends on the actually activated output coupling element. In FIG. 15b, this activation is achieved optically. An UV filter can e.g. be disposed on the plane surface of the array of collimating micro-lenses, or on the plane cover layer of the light guiding structure, so that no UV radiation is emitted towards the user.

Now, it depends on the actual position of the user which output coupling element(s) on the strip shaped light waveguide must be activated. According to a continuation of this invention, to achieve a deflection of the light in two directions, the light guiding structures of the illumination unit can for example be disposed side by side. Alternatively, the light waveguides can be arranged and generated in multiple layers of a substrate. This allows for example horizontal and vertical light waveguides to be disposed one atop the other, so that the collimated light can be deflected in multiple layers.

To be able to solve the object in an inventive manner, a number of conditions must be satisfied simultaneously in the illumination unit in order to get—based on the injected temporally coherent light—a wave field which also exhibits the required spatial coherence in addition to the required temporal coherence. This wave field now serves to illuminate an SLM in order to generate a reconstruction of a spatial scene in a holographic display device. The spatial coherence of the wave field to be realised and, derived from that, the size of the secondary light sources and the intensity distributions emitted by them are defined by the parameters of the optical components used in the holographic display device.

To manufacture such output coupling elements in practice, techniques are employed which also effect an axially symmetric distribution of the emitted light intensity in relation to the normal direction of the plane of the light waveguide. Further, output coupling elements can be designed such that their emitted intensity can be modified. This is necessary because in an optical fibre with normally high light efficiency the output coupling of light causes an attenuation in the light waveguide. Thanks to this variable design it is made sure that the output coupling elements which are reached last by the light also supply the required light intensity.

When generating and manufacturing the output coupling elements, particular importance must be attached to strictly complying with the specified parameters of the wave field to be generated. The output coupling elements must be modified both intrinsically and mutually such that the intensity of the light coupled out is almost constant after the collimating lenses. Then, the constancy across the entire surface of the illumination unit is ensured.

Another possibility of realising the light waveguide is to inscribe the optical fibre directly into a substrate with optically modifiable refractive index. This has the advantage that the entire manufacturing process can be carried out lithographically and by way of laser inscription. The output coupling elements shown in FIG. 6a can for example be generated using etching processes.

The light which is coupled out and collimated in accordance with one of the embodiments described above illuminates as a coherent plane two-dimensional wave field a controllable SLM on which a diffractive structure is encoded which represents a spatial scene. When it hits this diffractive structure, the coherent plane wave field is modulated such that it reconstructs the spatial scene, which can then be seen as a holographic reconstruction of the scene by an observer from a visibility region in the observer plane.

If a holographic 1D encoding is realised in one plane and a stereoscopic presentation is realised in the other plane (horizontal and vertical planes), then the plane wave spectrum of the illumination is very asymmetric. In the coherent plane it is limited e.g. to <1°/20 deg, and in the incoherent plane it is limited to <2° deg. This asymmetry can be realised by providing an analogously asymmetric form of the light sources. In such an embodiment, the output coupling elements have the form of a line segment.

1. Illumination unit which comprises a strip shaped light waveguide and an imaging means, where the light waveguide has a number of light output coupling elements for injected coherent light to be coupled out, and where the imaging means has imaging elements which deflect the light which is coupled out through a controllable spatial light modulation means into an observer plane, wherein the output coupling elements form in the light waveguide a two-dimensional grid of secondary light sources which are disposed in the front focal plane of the imaging elements and which realise spatial coherence at least one-dimensionally, where each secondary light source is assigned to one imaging element, which directs the emitted light in a collimated manner in the form of a plane two-dimensional wave field through the controllable light modulation means.

2. Illumination unit according to claim 1, wherein the strip shaped light waveguide is connected with a carrier means and has a continuous, non-linear structure.

3. Illumination unit according to claim 1, wherein the output coupling elements are generated either by way of mechanical or lithographic processing or with the help of diffraction gratings, or wherein the light waveguide is realised in the form of a multi-mode light waveguide where the individual modes exhibit a different energy distribution.

4. Illumination unit according to claim 1, wherein the light waveguide and the output coupling elements are inscribed by exposure directly into a holographic recording medium, or wherein the output coupling elements are generated by way of in-situ exposure, or wherein the light waveguide and the output coupling elements are inscribed by exposure directly into a holographic recording medium and wherein the output coupling elements are generated by way of in-situ exposure.

5. Illumination unit according to claim 2, wherein the light waveguide and/or the carrier means are at least partly covered by a photosensitive cover layer for generating the output coupling elements.

6. Illumination unit according to claim 5, wherein the output coupling elements in the light waveguide are exposed optionally into the photosensitive core or into the photosensitive cladding in the form of volume gratings which are locally confined to the light sources to be realised.

7. Illumination unit according to claim 6, wherein the grating plane of the exposed volume gratings has a planar or curved shape, depending on the size of the secondary light sources to be realised.

8. Illumination unit according to claim 1, wherein the light waveguide is realised by a GRIN lens, or wherein the light waveguide is realised by a GRIN lens and wherein the GRIN lens is inscribed by exposure into the transparent carrier means optionally in the form of a waveguide grating or in continuous windings at least two-dimensionally.

9-10. (canceled)

11. Illumination unit according to claim 1, wherein the output coupling elements generate secondary light sources in the form of point sources for illuminating the light modulation means which is encoded two-dimensionally.

12. Illumination unit according to claim 1, wherein the geometry and/or size of individual output coupling elements can be modified by individual diffraction gratings in order to control the intensity distribution of the light to be coupled out in the individual output coupling elements.

13. Illumination unit according to claim 1, wherein the imaging elements are provided in the form of an array of collimating lenses.

14. Illumination unit according to claim 13, wherein the collimating lenses and/or the output coupling elements are generated holographically.

15. Illumination unit according to claim 13, wherein an arrangement of apertures, whose apertures confine the light emission to the assigned collimating lenses, is provided between the output coupling elements and the array of collimating lenses.

16. Illumination unit according to claim 1, wherein the output coupling elements in the front focal plane extend over a region which is smaller than the surface of the light modulation means to be illuminated.

17. (canceled)

18. Illumination unit according to claim 6, wherein the volume grating is inscribed by exposure into the light waveguide optionally as a phase-only grating or as an amplitude-only grating.

19. Illumination unit according to claim 1, wherein the grid of secondary light sources exhibits a constant spacing or a period with distances increasing from the centre towards the edge of the grid.

20. Illumination unit according to claim 1, wherein the output coupling elements realise secondary light sources with an axially symmetric intensity distribution.

21. Illumination unit according to claim 1, wherein the light waveguide has coupling points where active modulators are provided for dimming the intensities of individual secondary light sources.

22. Illumination unit according to claim 1, wherein each imaging element is assigned with at least one output coupling element.

23. Illumination unit according to claim 1, wherein the output coupling elements are connected with a controllable layer with reversibly modifiable refractive index, so that the emitted light is directed at the assigned collimating imaging elements as varied depending on the actual control.

24. Spatial light modulation means into which a diffractive structure of a spatial scene is encoded and which is illuminated with a coherent plane wave field which is generated by an illumination unit according to claim 1.
